(19) United States
(12) Patent Application Publication
(10) Pub. No.: US 2012/0027931 A1
(43) Pub. Date: Feb. 2, 2012

(54) Coating Having Thermal and Non-Thermal Coating Method

(76) Inventors: Francis-Jurjen Ladru, Berlin (DE); Marco Reinger, Lauchringen (DE); Bernhard Siebert, Berlin (DE)

(21) Appl. No.: 13/146,737

(22) PCT Filed: Jan. 8, 2010
(86) PCT No.: PCT/EP10/50126

§ 371 Date: Oct. 14, 2011

(30) Foreign Application Priority Data
Jan. 28, 2009 (EP) 09001190.9

(51) Int. Cl. B05D 1/02

(52) U.S. Cl. 427/140

(57) ABSTRACT

A method for coating a substrate of a component is provided. Using the previous coating method, localized coating that can occur unexpectedly at one spot is often more difficult because the coating sequence must be reprogrammed here. This irregularity is resolved in a short period of time by a simple, manual coating.

### CROSS REFERENCE TO RELATED APPLICATIONS

This application is the US National Stage of International Application No. PCT/EP2010/050126, filed Jan. 8, 2010 and claims the benefit thereof. The International Application claims the benefits of European Patent Office application No. 09001190.9 EP filed Jan. 28, 2009. All of the applications are incorporated by reference herein in their entirety.

### FIELD OF INVENTION

The invention relates to the coating of a component, in which a first coating method and a second coating method are used in succession.

### BACKGROUND OF INVENTION

Components are often coated in order to protect the underlying substrate against corrosion, oxidation or heat.

Irregularities occurring, in this case during the coating process or in difficultly accessible regions may lead to irregularities in the coating as well as in the handling of the components.

Previously, coating robots have needed to be programmed in a very elaborate way for correction of the irregularity.

### SUMMARY OF INVENTION

It is therefore an object of the invention to provide a method which resolves the aforementioned problem by correcting the irregularities in a simplified and flexible way.

The object is achieved by a coating method in which, after the first coating method, in particular a thermal coating method, a second coating method, in particular a nonthermal coating method, different to the first is used in order to apply coating material on a difficultly accessible or simply repairable position.

### BRIEF DESCRIPTION OF THE DRAWINGS

FIG. 1 shows the sequence of the method,

FIG. 2 shows a gas turbine,

FIG. 3 shows a turbine blade,

FIG. 4 shows a combustion chamber.

The figures and the description merely represent an exemplary embodiment of the invention.

### DETAILED DESCRIPTION OF INVENTION

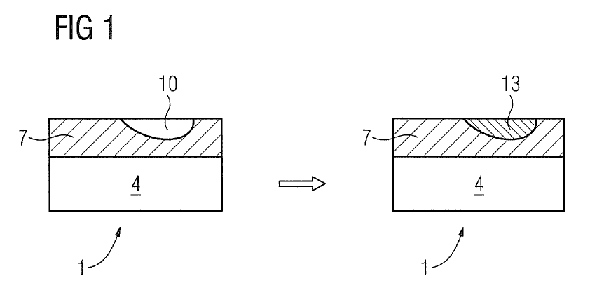

FIG. 1 represents, on the left, a component 1, 120, 130, 155.

The component 1 comprises a substrate 4 which, particularly in the case of turbine blades 120, 130, consists of a nickel- or cobalt-based superalloy.

One or more coatings 7 are applied onto the substrate 4. These may be protective metal coatings 7 (MCrAlX) and/or ceramic layers 7.

The coating 7, which is in particular the outermost layer of the layer system, has a local irregularity 10 at a position or has a difficultly accessible position 10. This may preferably be a necessary layer thickness which has not been reached or preferably positions on which there is no coating.

The layer 7 was applied in a first step by a first coating method, in particular a thermal spraying method such as preferably plasma spraying, HVOF or cold gas spraying.

The first coating method is preferably an automated or semiautomated coating method in a system, in which the substrate 4 is placed in a coating apparatus and then coated according to a selected program.

In a second method step, material 13 which eliminates the local irregularity 10 is additionally applied onto the local position 10 by means of a second coating method.

The position 10 is never the surface which was coated by the first coating method. In contrast to the first coating method, the second coating method is a local coating method for repair. Ceramic is preferably applied locally on ceramic, i.e. coating material is applied in the second coating method onto a layer which has already been produced by the first coating method.

The material 13 is applied by a second coating method, in particular a nonthermal coating method, different to the first. The second method is not plasma spraying, not CVD, not PVD, not HVOF and not cold gas spraying.

In particular, the second coating method is slurry application or slurry spraying.

The slurry preferably has the same chemical composition for the powder (coating material) as the material which was used during the first coating. In particular, the same grain size distribution is used as in the first coating. More preferably, a somewhat smaller grain size distribution is used (i.e. the average grain size is measurably smaller).

The term “nonthermal” refers to the temperature at which material is applied onto a substrate, i.e. whether the material is heated during the application (≧100° C., in particular >300° C.), and not to subsequent steps after the application, for example a debindering step or sintering.

The second coating method is preferably a manual coating method (brushing, casting, spreading, spraying, etc.).

A slurry is a mixture of a powder and at least one liquid (solvent) and optionally a binder.

The optionally provided binder is preferably driven off, and the material 13 may be debindered and/or compacted during use or simply in an oven and compensates for the irregularity 10 or eliminates it fully.

The elimination of the irregularity 10 takes place very rapidly and simply by the method in comparison with elaborate local coating in a coating apparatus. It can therefore also be used when defects become apparent after delivery, and in particular on site at the customer.

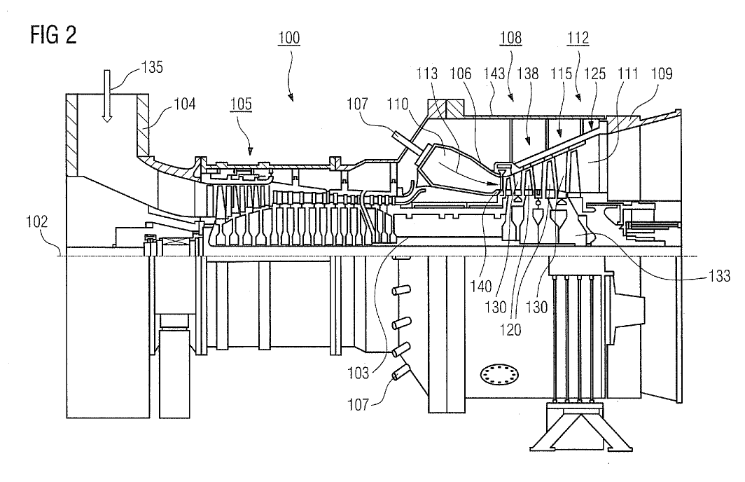

FIG. 2 shows a gas turbine 100 by way of example in a partial longitudinal section.

The gas turbine 100 internally comprises a rotor 103, which will also be referred to as the turbine rotor, mounted so as to rotate about a rotation axis 102 and having a shaft.

Successively along the rotor 103, there are an intake manifold 104, a compressor 105, an e.g. toroidal combustion chamber 110, in particular a ring combustion chamber, having a plurality of burners 107 arranged coaxially, a turbine 108 and the exhaust manifold 109.

The ring combustion chamber 110 communicates with an e.g. annular hot gas channel 111. There, for example, four successively connected turbine stages 112 form the turbine 108.

Each turbine stage 112 is formed for example by two blade rings. As seen in the flow direction of a working medium 113, a guide vane row 115 is followed in the hot gas channel 111 by a row 125 formed by rotor blades 120.

The guide vanes 130 are fastened on an inner housing 138 of a stator 143 while the rotor blades 120 of a row 125 are fitted on the rotor 103, for example by means of a turbine disk 133.

Coupled to the rotor 103, there is a generator or a work engine (not shown).

During operation of the gas turbine 100, air 135 is taken in and compressed by the compressor 105 through the intake manifold 104. The compressed air provided at the turbine-side end of the compressor 105 is delivered to the burners 107 and mixed there with a fuel. The mixture is then burnt to form the working medium 113 in the combustion chamber 110. From there, the working medium 113 flows along the hot gas channel 111 past the guide vanes 130 and the rotor blades 120. At the rotor blades 120, the working medium 113 expands by imparting momentum, so that the rotor blades 120 drive the rotor 103 and this drives the work engine coupled to it.

The components exposed to the hot working medium 113 experience thermal loads during operation of the gas turbine 100. Apart from the heat shield elements lining the ring combustion chamber 110, the guide vanes 130 and rotor blades 120 of the first turbine stage 112, as seen in the flow direction of the working medium 113, are heated the most.

In order to withstand the temperatures prevailing there, they may be cooled by means of a coolant.

Substrates of the components may likewise comprise a directional structure, i.e. they are single-crystal (SX structure) or comprise only longitudinally directed grains (DS structure).

Iron-, nickel- or cobalt-based superalloys are for example used as the material for the components, in particular for the turbine blades 120, 130 and components of the combustion chamber 110.

Such superalloys are known for example from EP 1 204 776 B1, EP 1 306 454, EP 1 319 729 A1, WO 99/67435 or WO 00/44949.

The guide vane 130 comprises a guide vane root (not shown here) facing the inner housing 138 of the turbine 108, and a guide vane head lying opposite the guide vane root. The guide vane head faces the rotor 103 and is fixed on a fastening ring 140 of the stator 143.

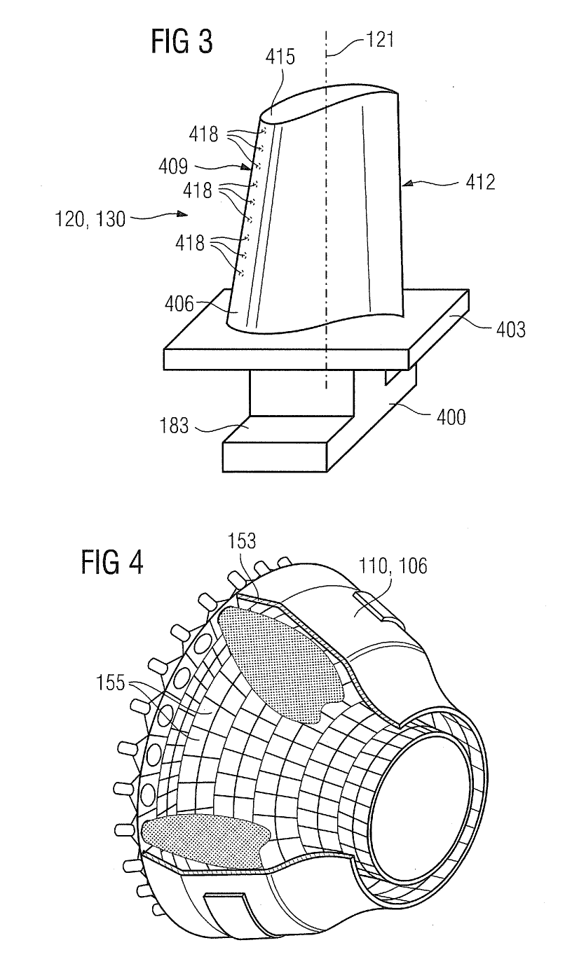

FIG. 3 shows a perspective view of a rotor blade 120 or guide vane 130 of a turbomachine, which extends along a longitudinal axis 121.

The turbomachine may be a gas turbine of an aircraft or of a power plant for electricity generation, a steam turbine or a compressor.

The blade 120, 130 comprises, successively along the longitudinal axis 121, a fastening region 400, a blade platform 403 adjacent thereto as well as a blade surface 406 and a blade tip 415.

As a guide vane 130, the vane 130 may have a further platform not shown) at its vane tip 415.

A blade root 183 which is used to fasten the rotor blades 120, 130 on a shaft or a disk (not shown) is formed in the fastening region 400.

The blade root 183 is configured, for example, as a hammerhead. Other configurations as a firtree or dovetail root are possible.

The blade 120, 130 comprises a leading edge 409 and a trailing edge 412 for a medium which flows past the blade surface 406.

In conventional blades 120, 130, for example solid metallic materials, in particular superalloys, are used in all regions 400, 403, 406 of the blade 120, 130.

Such superalloys are known for example from EP 1 204 776 B1, EP 1 306 454, EP 1 319 729 A1, WO 99/67435 or WO 00/44949.

The blade 120, 130 may in this case be manufactured by a casting method, also by means of directional solidification, by a forging method, by a milling method or combinations thereof.

Workpieces with a single-crystal structure or single-crystal structures are used as components for machines which are exposed to heavy mechanical, thermal and/or chemical loads during operation.

Such single-crystal workpieces are manufactured, for example, by directional solidification from the melt. These are casting methods in which the liquid metal alloy is solidified to form a single-crystal structure, i.e. to form the single-crystal workpiece, or is directionally solidified.

Dendritic crystals are in this case aligned along the heat flux and form either a rod crystalline grain structure (columnar, i.e. grains which extend over the entire length of the workpiece and in this case, according to general terminology usage, are referred to as directionally solidified) or a single-crystal structure, i.e. the entire workpiece consists of a single crystal. It is necessary to avoid the transition to globulitic (polycrystalline) solidification in these methods, since nondirectional growth will necessarily form transverse and longitudinal grain boundaries which negate the beneficial properties of the directionally solidified or single-crystal component.

When directionally solidified structures are referred to in general, this is intended to mean both single crystals which have no grain boundaries or at most small-angle grain boundaries, and also rod crystal structures which, although they do have grain boundaries extending in the longitudinal direction, do not have any transverse grain boundaries. These latter crystalline structures are also referred to as directionally solidified structures.

Such methods are known from U.S. Pat. No. 6,024,792 and EP 0 892 090 A1.

The blades 120, 130 may also have coatings against corrosion or oxidation, for example MCrAlX (M is at least one element from the group iron (Fe), cobalt (Co), nickel (Ni), X is an active element and stands for yttrium (Y) and/or silicon and/or at least one rare earth element, or hafnium (Hf)). Such alloys are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermally grown oxide layer) is formed on the MCrAlX layer (as an interlayer or as the outermost layer).

The layer composition preferably comprises Co-30Ni-28Cr-8Al-0.6Y-0.7Si or Co-28Ni-24Cr-10Al-0.6Y. Besides these cobalt-based protective coatings, it is also preferable to use nickel-based protective layers such as Ni-10Cr-12Al-0.6Y-3Re or Ni-12Co-21Cr-11Al-0.4Y-2Re or Ni-25Co-17Cr-10Al-0.4Y-1.5Re.

On the MCrAlX, there may furthermore be a thermal barrier layer, which is preferably the outermost layer and consists for example of ZrO₂, Y₂O₃—ZrO₂, i.e. it is not stabilized or is partially or fully stabilized by yttrium oxide and/or calcium oxide and/or magnesium oxide.

The thermal barrier layer covers the entire MCrAlX layer.

Rod-shaped grains are produced in the thermal barrier layer by suitable coating methods, for example electron beam deposition (EB-PVD).

Other coating methods may be envisaged, for example atmospheric plasma spraying (APS), LPPS, VPS or CVD. The thermal barrier layer may comprise porous, micro- or macro-cracked grains for better thermal shock resistance. The thermal barrier layer is thus preferably more porous than the MCrAlX layer.

The blade 120, 130 may be designed to be hollow or solid. If the blade 120, 130 is intended to be cooled, it will be hollow and optionally also comprise film cooling holes 418 (indicated by dashes).

FIG. 4 shows a combustion chamber 110 of the gas turbine 100. The combustion chamber 110 is designed for example as a so-called ring combustion chamber in which a multiplicity of burners 107, which produce flames 156 and are arranged in the circumferential direction around a rotation axis 102, open into a common combustion chamber space 154. To this end, the combustion chamber 110 as a whole is designed as an annular structure which is positioned around the rotation axis 102.

In order to achieve a comparatively high efficiency, the combustion chamber 110 is designed for a relatively high temperature of the working medium M, namely about 1000° C. to 1600° C. In order to permit a comparatively long operating time even under these operating parameters which are unfavorable for the materials, the combustion chamber wall 153 is provided with an inner lining formed by heat shield elements 155 on its side facing the working medium M.

Owing to the high temperatures inside the combustion chamber 110, a cooling system may also be provided for the heat shield elements 155 or for their retaining elements. The heat shield elements 155 are then hollow, for example, and optionally also have cooling holes (not shown) opening into the combustion chamber space 154.

Each heat shield element 155 made of an alloy is equipped with a particularly heat-resistant protective layer (MCrAlX layer and/or ceramic coating) on the working medium side, or is made of refractory material (solid ceramic blocks).

These protective layers may be similar to the turbine blades, i.e. for example MCrAlX: M is at least one element from the group iron (Fe), cobalt (Co), nickel (Ni), X is an active element and stands for yttrium (Y) and/or silicon and/or at least one rare earth element, or hafnium (Hf). Such alloys are known from EP 0 486 489 B1, EP 0 786 017 B1, EP 0 412 397 B1 or EP 1 306454 A1.

On the MCrAlX, there may furthermore be an e.g. ceramic thermal barrier layer which consists for example of ZrO₂, Y₂O₃—ZrO₂, i.e. it is not stabilized or is partially or fully stabilized by yttrium oxide and/or calcium oxide and/or magnesium oxide, etc.

Rod-shaped grains are produced in the thermal barrier layer by suitable coating methods, for example electron beam deposition (EB-PVD).

Other coating methods may be envisaged, for example atmospheric plasma spraying (APS), LPPS, VPS or CVD. The thermal barrier layer may comprise porous, micro- or macro-cracked grains for better thermal shock resistance.

Refurbishment means that turbine blades 120, 130 or heat shield elements and other hot-gas components 155 may need to be stripped of protective layers (for example by sandblasting) after their use. The corrosion and/or oxidation layers or products are then removed. Optionally, cracks in the turbine blade 120, 130 or heat shield element 155 are also repaired. The turbine blades 120, 130 or heat shield elements 155 are then recoated and the turbine blades 120, 130 or heat shield elements 155 are used again.

1-13. (canceled)

14. A method for coating a substrate of a component, comprising:
using a first coating method in a first step in order to produce a layer which includes a local irregularity; and
eliminating the local irregularity by a second coating method,
wherein the second coating method is different than the first coating method.

15. The method as claimed in claim 14, wherein the first coating method is a thermal spraying method.

16. The method as claimed in claim 14, wherein the second coating method is a nonthermal coating method.

17. The method as claimed in claim 16, wherein the second coating method or the nonthermal spraying method is a slurry application.

18. The method as claimed in claim 16, wherein the second coating method or the nonthermal spraying method is a slurry spraying.

19. The method as claimed in claim 14, wherein the layer is a ceramic layer.

20. The method as claimed in claim 14, wherein the first coating method is an automatic or semiautomatic coating method.

21. The method as claimed in claim 14, wherein the second coating method is a manual method.

22. The method as claimed in claim 15, wherein the first coating method or the thermal spraying method is selected from the group consisting of plasma spraying, HVOF and cold gas spraying.

23. The method as claimed in claim 17, wherein a binder is used in the slurry.

24. The method as claimed in claim 17, wherein no binder is used in the slurry.

25. The method as claimed in claim 18, wherein a binder is used in the slurry.

26. The method as claimed in claim 18, wherein no binder is used in the slurry.

27. The method as claimed in claim 14, wherein the first and second methods use the same coating material.

28. The method as claimed in claim 14, wherein a coating material is applied by the second coating method onto a layer which was produced by the first coating method.

29. The method as claimed in claim 21, wherein a coating material is sprayed during the second coating method.

30. The method as claimed in claim 14, wherein the method is used to repair the component.
